(19) United States
(12) Patent Application Publication
(10) Pub. No.: US 2024/0029103 A1
(43) Pub. Date: Jan. 25, 2024

(54) AI-Based Advertisement Prediction and Optimization Using Content Cube Methodology

(71) Applicant: AiAdvertising, Inc., San Antonio, TX (US)

(72) Inventors: Kevin Myers, San Antonio, TX (US); Jerry Hug, San Antonio, TX (US)

(21) Appl. No.: 18/139,652

(22) Filed: Apr. 26, 2023

Related U.S. Application Data
(60) Provisional application No. 63/335,133, filed on Apr. 26, 2022.

(51) Int. Cl. G06Q 30/0242

(52) U.S. Cl. CPC G06Q 30/0244

(57) ABSTRACT

A Multidimensional Framework and virtualized data repository (‘Content Cube’) and AI-based SaaS Workflow Platform for the intelligent prediction of one or multiple digital advertising designs, which are curated and hyper-localized according to (1) the attributes and features of target customers segmented firstly by their underlying personalities, interests, and behaviors at a given stage in their customer journey and secondly; (2) how such generalized personas are manifest as situationally specific behavior triggers and motivational drivers relative to the unique context and needs of the Client's ad campaign mandate (i.e., brand and marketing mix, content calendar, ad campaign goals and KPIs, choice of medium/media channel, client budget, etc.) against which the performance of the Creative may be measured in real-time and modified dynamically as needed.

### FIELD OF THE DISCLOSURE

The present disclosure is generally related to advertising

### BACKGROUND

The existing Ad Agency model is expensive, slow, and reactive. It often creates internalized views of what client customers to come up with creative templates which are used well beyond their active life and are not personalized or localized for each unique customer;

A plethora of adtech companies use the terms contextual advertising, ad personalization, etc. This genre of adtech company pushes existing digital ads to a specific target customer based on unique identifiers (cookies, IP addresses, MAC address) based on their prior searches, social media or e-commerce activity. This information is often provided by these companies directly or via reseller services. Not only will much of this data no longer be available due to new privacy rules, but such data is only relative to existing Creative which is pushed through these medium and the feedback on the performance of these Ads is slow in coming and not particularly insightful—it says what didn't work but not why or how.

The notion of digital ad creation is not new, but current solutions have access to very narrow data points. The design briefs are summarized in aggregated form and simply cannot be scaled to be customer or client-specific. Such sources are useful but not sufficient for hyper-localized predictive creative.

### BRIEF DESCRIPTIONS OF THE DRAWINGS

FIG. 1: Illustrates a System for advertising creative assessment, according to an embodiment.

FIG. 2: Illustrates a Base Module, according to an embodiment.

FIG. 3: Illustrates a Client Intake Module, according to an embodiment.

FIG. 4: Illustrates a Data Collection Module, according to an embodiment.

FIG. 5: Illustrates a Data Formatting Module, according to an embodiment.

FIG. 6: Illustrates an Admin Database, according to an embodiment.

FIG. 7: Illustrates a Data Tagging Module, according to an embodiment.

FIG. 8: Illustrates a Data Linking Module, according to an embodiment.

FIG. 9: Illustrates a Performance Module, according to an embodiment.

FIG. 10: Illustrates a Performance Database, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention

Further, many of the embodiments described herein are described in terms of sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

With the presently disclosed AIAD platform billions of data points can be generated related to insights, signals and sentiment. This information can be used to predict and target micro-audiences, including the prediction of actual ‘real life’ personalities of a customer in the metaverse and push appropriately targeted creative and copy to a group or audience; predict the virtual personality of the customer (for example an avatar) and push appropriately targeted creative and copy to this singular or group audience, and predict the actual conversion event of the virtual personality (e.g., for further engagement, purchase, loyalty etc) as it relates to purchases or engagements it transitions from virtual personality to real personality and real consequences.

A further embodiment relates to genomics where correlations between persona types and underlying fully-sequenced DNA trained data sets may be developed.

Artificial intelligence (AI) refers to the simulation of human intelligence in machines. The machines are programmed to think like humans and mimic their actions. In one embodiment, this invention can integrate and use this AI technology and processes. AI techniques include domain-expert-driven rule based systems that use rules to make deductions or narrow down choices. In rule-based systems, knowledge is encoded in the form of facts, goals, and rules and is used to evaluate and manipulate data. AI techniques may also include natural language processing (NLP) that analyze text and determine attributes of the text such as content, tone, keywords, named entities, topic, etc. AI techniques may also include time-series optimization that predict patterns or trends in time related data, such as patterns that occur based on seasons, holidays, or are related to macro-economic events such as a recession or a war. AI techniques may also include linear regression and clustering analysis which are techniques to organize, predict, extrapolate, and visualize data. These are examples of AI techniques, but additional AI techniques may also be used and combinations of techniques may be used.

AI has a dramatic effect on all aspects of advertising, marketing, and the consumer communication landscape. Advertisers and marketers are pursuing all available paths to optimize the vast amounts of available data to create better, more effective, and productive advertising campaigns and drive improved consumer impact and results.

The importance of AI in advertising shows a demonstrable increase in use, creating an environment where it's now possible to precisely measure the effectiveness of messaging, creative execution, and overall campaign success against specific goals and objectives. AI also enhances the customer journey and specifically determines the optimal allocation of resources within various media. In one embodiment, this invention can integrate and use this AI technology and processes.

With a surge in available customer touchpoints and an overload of consumer information, the development of hyper-personalized communication and customized consumer experience is now becoming a significant trend in the advertising and marketing industries.

Customers are increasingly likely to purchase from an organization that offers personalized products and services based on their individual preferences. As a result, there is a major shift to leverage current technology to create a more personalized approach in providing products and services to customers, increasing sales and ROI in advertising and marketing investment spending.

Media spending and resource allocation are not the only segments of the advertising industry being affected. AI impacts all aspects of communication planning, analytics, and creative execution. AI-based advertising is transforming the entire industry. As the inclusion of AI, machine learning, and metadata becomes more widespread, advertisers can make better decisions with their budgets to maximize ROI. In one embodiment, this invention can integrate and use this AI to connect metadata tags to the efficacy of media spending.

AI provides a competitive advantage to all components of the advertising process through improved user experiences, real-time monitoring of media, dynamic recalibration of messaging, data blending, persona classifications, and reduction in human error when analyzing large data sets. The benefits are immediately measurable, and organizations see improvements in sales results. In one embodiment, this invention can integrate and use this AI technology and processes.

Organizations are increasing their investment in AI to Improve and personalize the customer experience experiences—specifically. Most consumers want experiences tailored to their specific needs and wants. The latest research trends indicate that US customers are willing to trade personal information for a more personalized message and product relevancy from retailers and other sellers. In one embodiment, this invention can integrate and use this AI to customize advertising for customers' specific needs and wants.

Personalized advertising allows the seller to cultivate meaningful retail relationships with consumers across media touchpoints and platforms. Personalized conversational techniques and optimizing creative messaging offer a much-preferred process to connect with targeted consumer audiences, increasing brand loyalty and providing deeper customer engagement along the customer journey.

Identifying and selecting the most relevant thought leaders and influencers is becoming increasingly important for brands looking to develop more personal connections among consumers. Selecting the right influencers can be a challenge; however, leveraging AI can significantly improve generating a content strategy that can increase engagement across all media platforms. In one embodiment, this invention can integrate and use this AI to identify influencers who align with their content strategies.

Ideal target audience selection is among the primary challenges facing marketers and advertisers in today's complex media-consuming environment. AI technology can effectively analyze many data sources from CRM, client, and third party sources to determine the probability of a consumer taking a specific action, thereby making campaigns more effective and providing actionable and highly refined iterative results. AI can create micro-targeted look-alike audiences based on past campaigns to target new contacts and accelerate sales.

AI and geolocation data together with Google Analytics, social media analytics, messaging and chat feeds, business intelligence (BI) tools, CRM, digital marketing platforms, and other consumer data are also incorporated into audience segmentation and engagement predictors to drive sales, increase local retail foot traffic and encourage personalized recommendations based on a variety of purchase triggers. In one embodiment, this invention can integrate and use geolocation data to segment audiences.

A key element of digital communication and advertising is creating the customer profile, more commonly referred to as a buyer's “persona.” These personas are fictionalized characters representing a typical consumer's identity, personality traits, and purchasing habits in a specific market sector, subset, or target demographic.

Advertising professionals traditionally produce and manage personas through research, imagination, and input from various sources based on existing customers' consumer behavior and buying practices in segmented databases. As machine-learning technologies have improved, advances in data analytics and Artificial Intelligence (AI), marketing personas can now be created and managed with minimal human intervention. In one embodiment, this invention can integrate and use this AI technology and processes to create personas.

Creating and integrating marketing personas to improve the customer journey enhances the marketer's ability to create long-lasting consumer relationships and nurture customer interaction with a specific brand or purchase experience. Customers may be individuals or may be businesses, communities, governments, or any other entity where building a relationship is critical to successful advertising

Improving customer interactions via highly specified marketing personas with a brand or product will: ensure products or services are actually what the consumer needs or wants, the ease of searching for a particular service or product is vastly improved, evaluation of purchase options are clear, and interactions with the seller for technical support, service, and information is satisfactory. These customer interactions apply to products or services in almost any consumer category. In one embodiment, this invention can integrate personas as a mechanism for categorizing and or linking data sources

Brands and services must provide offerings relevant to their customer base, tailoring advertising and messaging programs and promotional materials to personal characteristics and issues relevant to the target customer. Advertising programs that conduct broad-based, generic messaging to a particular demographic alone will not have the ROI and success of a carefully built multidimensional continuous marketing process. Accurate and consistently updated marketing personas are essential for improving brand awareness and closed sales. In one embodiment, this invention can integrate and use AI to continuously update marketing personas.

Machine-learning (ML) technology is a subset of AI that has the capability to process and analyze millions of data records and automate decision-making for individual data subjects based on the analysis of inputs from multiple data streams. More data being fed into the process will reduce the risk of data tunneling and bias. By accurately processing transactional and behavioral data from consumers who share common traits with a specific marketing persona, ML systems can define specific advertising creative, messaging, and media platforms that perform best for a particular marketing persona. With a depth of knowledge and actionable research, marketers can create materials that meet the needs of that specific group or subgroup. As technology becomes more automated and reaches disparate data sets, system can be configured to support content creation and delivery processes easily and effectively.

Marketing and advertising professionals can now create materials for various media platforms (web, social media broadcast, OTT, DTV videos, etc.) containing relevant information to their targeted customer base and “speaking the buying language” of a specific marketing persona or customer profile. The AI process can determine specific content and messaging for each individual within that marketing persona. In one embodiment, this invention can integrate and use this AI technology and processes to create content specific to a marketing persona.

Implementing “omnichannel” marketing programs—(i.e., presenting a consistent message to the consumer across all their points of contact with an organization) presents challenges to the marketer in that each personal media device may contain different account profiles (or media preferences). Maintaining a consistent marketing persona across all channels is key to ensuring optimum sales results.

Building a “real life” marketing persona is based on the activities of real people from a variety of primary and secondary data sources that closely resemble fictionalized persona constructs. This data can include age, behavioral characteristics, habits, adoption curve classifiers, blended psychometric classifiers, socio-economic geographic, etc. Information is updated consistently with real-time data from existing customers via multiple consumer platforms to maintain accurate persona profiles. This data is collected from various data files and channels such as e-commerce, websites, GL/ERP, marketing data, engagement statistics, ratings/surveys, and other transactional sources.

Data privacy is of critical importance in the development of marketing personas. Maintaining regulatory compliance and customer privacy is non-negotiable, and systems need to be in place to ensure all identifiable data is held confidential. Maintaining human control over these systems will assure customers that adherence to all established rules and regulations is strictly upheld and observed. In one embodiment, this invention can integrate human and AI privacy measures to secure customer data.

Persona development focus includes more than a collection of consumer data points—but also considers gathering information on the emotional taxonomy, interests, and motivations that define consumers as humans with individual personalities and habits. Consumer emotional and behavior triggers can help create personas that can effectively identify audiences deploying the right content—because the marketer understands specific consumer drivers and motivators. For example, combining psychographic, demographic, and behavior metrics can accurately create a market persona. Data sets can further help identify innovators, early adopters, introverts, extroverts, people-oriented, task-oriented analytical, etc.

These metrics are extremely powerful and assist marketers to better understand their consumers and particular affinities. Qualitative measures reveal key trends to help successfully segment consumers specific to personality, attitude, personal values, lifestyle, social structure, activities, interests, opinion groups, and subsets. As data is blended and synthesized via AI technology, marketers can connect how a specific persona interacts with their product or brand. Correctly implementing and deploying this information is critical to improving advertising and marketing results. Consumer behavior naturally drives purchase decisions via emotions and values, not simply because they belong to a demographic subset. In one embodiment, this invention can leverage AI to use these metrics to predict customer behavior.

Maximizing the full potential of marketing personas requires continuous updating as customers continue to evolve as individual buying habits change constantly. For each possible persona, there are primary archetypes within specific communication tactics in terms of what a user values and the persuasion tactics and messaging techniques that have the maximum impact in achieving a sale. People have become accustomed to receiving personalized product and service content, setting an expectation that anything less seems unsatisfactory. Targeted content versus generic content is consistently preferred among consumers. In one embodiment, this invention can integrate and use AI to target specific personas with customized marketing content.

AI is designed to constantly refine customer persona. Creating personalized content for different customer segments increases the chances of closing sales. This is accomplished via (1) the sheer amount of data points available on consumer actions, (2) transactional and behavioral data shared in common within a persona profile, (3) the digital experience increases the relevance of the product or service offering, (4) the speed and scale upon which new data becomes available for analysis, (5) messaging can be refined almost instantaneously, improving engagement strategy along the customer journey, (6) the AI process is becoming more cost-effective, and (7) AI persona-based marketing sophistication is now within reach of even smaller companies. In one embodiment, this invention can integrate and use this AI technology and processes to continuously refine the persona segmentation and creation.

Analyzing the right meta and psychographic data sets can accelerate marketing and advertising decision speed. As market drivers change quickly, micro-targeted and personalized ads remain relevant to the target audience. In one embodiment, this invention can integrate and use AI to define the right meta a psychographic data sets to use for different personas.

Advertisers and marketers have always faced the challenge of determining the effectiveness of ad campaigns and identifying the process(es) needed to improve their results. Leveraging advanced analytics can help companies determine the most effective, i.e., when specific messaging is necessary, how the proper creative visual is deployed, and the optimum budget and ideal target audience. The combination of these factors reduces advertising waste and improves marketing ROI significantly.

Implementing an effective AI strategy in advertising requires a robust IT infrastructure that can accommodate the data analysis volume required for measurable success. With the increased availability of data from many sources, the challenge is to manage both the quality and marketing insights derived from the information. Purchase conversions and interactions happen continuously across multiple channels in both online and offline environments.

The vast amounts of data from e-commerce, website, ERP (enterprise resource planning), advertising analytics, engagement statistics, ratings and payment, and purchasing and other disparate sources can make it more difficult to plan for longer-term initiatives—since the data sets include new and valuable information that changes constantly. In addition, third-party sourced data such as demographic, geographic, industry reports, business intelligence, market analytics, and financial data merge to form an interconnected labyrinth that requires constant analysis and reporting. The outputs and insights generated from AI are only as useful as the timeliness and validity of source data upon which decisions are based. Navigating and synthesizing data and ensuring the collected information stays current is a critical part of the challenge. High-quality data and the analytical tools to synthesize and decipher it are critical to creating actionable advertising and marketing insights. In one embodiment, this invention can integrate and use this AI technology and processes to generate actionable insights from third-party data.

Emerging regulations concerning user privacy require AI tools to be compliant on multiple legal levels. Privacy laws differ across countries or even across state lines; therefore, implementing AI to connect with individuals in the consumer marketplace requires the latest legal guidance and structure. With the advances in AI technologies, the opportunity to provide “audit trails” will help ensure advertising messaging reaches both diverse and inclusive markets and consumers. In some cases, accurate audit trails can be used to effectively head off legal challenges and lawsuits. In one embodiment, this invention can integrate and use AI to create privacy audit trails.

As technology advances and becomes more sophisticated, well-trained and qualified experts from multiple disciplines must manage this technology. Data scientists and expert marketing professionals are required to decipher the data, and managers must ensure that data remains relevant and clean.

The application of applying AI to advertising enables a continuous multidimensional process that: leverages the right media platforms to connect customers with a product or service a relevant and contextual methodology; helps create more effective advertising messaging to bring conversational marketing techniques to the forefront of a marketing/media strategy; considers user data to provide prospective information about a particular brand and nurtures a one-on-one connection with the consumer. AI can improve the iterative data processing process and other functions with minimal human supervision with machine learning.

AI technology can rapidly evaluate millions of data points, synthesize, blend and correlate them together, reaching specific inferences and conclusions from these vast data sets and “learn” from each experience, improving and refining data scoring and validation capabilities with each iteration. As a result, AI tools and techniques can more accurately evaluate and predict events or factors much faster than human analysis. Machine learning algorithms allow advertisers to build more accurate buyer personas and predict how they think and act. In one embodiment, this invention may leverage machine learning to predict user behavior based on their assigned persona.

By leveraging machine learning, advertisers can detect patterns based on audience behavior and message resonance. AI can quickly process large quantities of available information about individual personas, such as demographics, online behavior, geolocation data, socio-economic information, and transactional data—all designed to decide the type of content a niche audience segment wishes to see/receive. Understanding an audience is imperative to increasing engagement and enhancing the customer journey. In one embodiment, this invention can integrate and use AI to increase user engagement by delivering more customized materials.

AI technology can help advertisers reach the right audience at the right time—when consumers are most ready to consider taking buying action. Synthesized data techniques can amplify micro-targeting and hyper-personalized activation strategies based on location, predictive consumer behavior, product sales patterns, demographic and psychographic profiles.

The ability of AI to generate contextual advertising messaging and creative imagery further determines which ad is the most appropriate to reach a specific target audience. Continuous analysis, meta scores, and measures enable the creative content to refine messaging and ad placements within the most productive media channels. In one embodiment, this invention can integrate and use AI to generate contextual advertising that is customized for a target audience.

Scoring and generating creative assets via AI provides insights, and performance-based metrics provide precise analytics that helps creative and marketing staff plan and design personalized communications campaigns more effectively. Automated intelligence can quickly interpret consumer video messaging and provide auto-tags for more productive results. In addition, creative assets can be translated to metadata for even more advanced search functionality. In one embodiment, this invention can integrate and use AI to score creative assets.

The latest Generative Adversarial Networks (GAN) architectures and AI image synthesis can generate high-resolution, realistic, and colorful images that are almost impossible to distinguish from original photography. Cost-effective video and assorted imagery can automatically be generated via AI modeling, tailored to fit a specific customer and brand. In one embodiment, this invention can integrate and use GANs to create customized images for creative assets.

AI capabilities are not limited to the generation of visual content. The advances in natural language processing (NLP) and natural language generation (NLG) have made artificial intelligence a part of the creative copywriting process. The marketing messages generated with AI-driven solutions are not only credible but also data-driven—the text can reflect the brand's voice and be tailored to specific audiences and audience subsets.

Understanding the drivers of creative effectiveness is critical to the success of a marketing campaign. Significant advances in machine learning have enabled marketers to analyze their creative assets almost instantaneously. AI technology can identify, tag, and create structured data for elements to present in a creative execution—for instance, should more people be featured in an ad, should the product be present, should the brand be mentioned in the audio. These creative learnings can now be effectively deployed at scale, and the resulting data and campaign optimizations can leverage the full potential of AI creative technology. In one embodiment, the present invention can leverage AI to identify drivers of the effectiveness of creative assets.

New AI mapping tools can score creative effectiveness and incorporate best practices for creative production and unique guidelines for a specific brand. AI can help manage global marketing teams across creative agencies, internal teams, and hundreds of markets to produce content that meets and exceeds marketing goals—without restricting the creative process. In one embodiment, this invention can integrate and use AI to score creative assets.

Customer data has traditionally been gathered and assembled among multiple legacy and disconnected systems. This data has typically been limited to service call centers and point-of-sale information. With accelerated digitization and advanced data technologies, organizations can synthesize and weigh proprietary and third-party data to create detailed profiles of customers and better understand their preferences and behaviors. With the emergence of “big data,” creating a hyper-personalized customer experience is emerging as a primary driver among consumer and business-to-business sellers. Organizations now can identify exact customer needs and requirements with the help of behavioral data and instantaneously interpret individual characteristics. This can be accomplished with the help of emerging AI-based tools and unified “data lake” repositories. These new and emerging technologies drive marketing and advertising to a more personalized customer-focused level than ever before. In one embodiment, the present invention can leverage AI to collet and standardize customer data from a variety of different sources to create a data lake that allows for all of the disparate data sources to be formatted and searchable.

Hyper-personalization utilizes and leverages real-time data to create meaningful insights by incorporating behavioral analytics to deliver highly relevant services and individually tailored to customers' expressed and underlying consumer needs. Consumers are welcoming a more tailored buying experience, and the customer journey is being vastly improved to meet customer expectations. Hyper-personalized marketing provides the opportunity for organizations to meaningfully engage customers, deepen existing relationships, build new ones, drive brand loyalty, increase the willingness to spend, and improve overall marketing effectiveness. In one embodiment, this invention can integrate and use hyper-personalized material in real-time by leveraging AI.

The ability to convert multiple and disparate data sources, whether structured, unstructured, or semi-structured, into machine-readable form, without affecting the integrity of 1^{st} or 3^{rd} party data records is a key factor in successfully personalizing the customer experience. Behavioral, contextual, demographic, and firmographic data alongside AI in real-time enables the personalization of a customer's entire purchase experience. Firmographics refers to a collection of descriptive attributes used by organizations to segment their target market and discover their “ideal” customers. These data sets help categorize companies according to geographic location, industry, customer base, type of organization, technologies used, etc. With this information at hand, you can build a more effective targeting strategy to improve marketing and sales campaigns.

When evaluating and deploying audience hyper-personalization techniques, there are key points of distinction within the nature of the personalization process. Most hyper-personalization can be done in real-time, meaning that analytical personalization capabilities can take a visitor's browsing or buying behavior, content interactions, device type, and other context clues to automatically display personalized advertising or sales offer messages. While personalization is often rule-based, hyper-personalization often leverages data that's been mined, blended, and synthesized from larger and more diverse data sets. AI personalization techniques can help identify these opportunities and launch hyper-personalization campaigns resulting in significantly improved results and ROI. In one embodiment, this invention can integrate and use this AI technology and processes to perform real-time personalization of creative assets.

Simple personalization often takes one or several data points into consideration. Hyper personalization includes many data points. Hyper personalization benefits include: higher sales closing rates—rather than multiple unsuccessful sales attempts, hyper-personalization allows customization of product or service offering(s) to the customer at the perfect time. On the front end of the sales process, advertisers and sellers can more accurately target specific offers. On the back end, advertisers and sellers can utilize customer insights to improve subsequent iterations of data models and predictive methodology. Hyper personalized marketing and sales efforts can eliminate prospects that don't wish to be contacted only reaching prospects who offer an ideal fit for a specific product or service. When prospective customers are precisely aligned with the correctly targeted product or service offered, consumer trust is earned, and brand integrity in the customer's mind is reinforced. In one embodiment, this invention can integrate and use AI to precisely align creative with a target audience.

Data quality is critical in ensuring that advertising analysis, evaluation, and the correlation of millions of data points yield accurate insights and predict consumer behavior. More than half of US digital spending is now programmatic advertising assisted by AI. Privacy concerns around correlating data from multiple sources also raise sales conversion and ROI tracking concerns.

For users of AI, technical tasks and implementation remain among the greatest challenge(s) in the implementation process. Critical to implementing a hyper-personalized framework is data collection and amalgamation. Extracting and translating extremely large data sets into accurate meta signals and measures takes significant resources, time, and talent. Without these components, it will be difficult to ascertain and create customer profiles and optimize customer behaviors and predictors. Even with new AI technologies, customers report that brands often fail to understand them as individuals. Therefore, collecting accurate and relevant data is essential to launching an effective automated customer engagement platform. In one embodiment, this invention can integrate and use AI to better understand the relationship between a brand and its customers.

The data collected, coupled with NLP tools trained on proprietary pattern recognition frameworks, will explain how customers interact with a particular brand. These tools assist in creating and providing hyper-personalized messages and experiences to specific customers based on behavioral characteristics and purchasing intent. Scaling the hyper-personalization process is incomplete without accurately categorizing customers into various subsets based on average spend, location, demographics, satisfaction, brand interaction history, etc. After fully connecting, organizing, and cleansing data, it can be transformed to engage, sell, and gain loyal customers. In one embodiment, this invention can integrate and use NLP to organize, format, and cleanse data for use by an AI algorithm.

Once customers are identified and segmented, the creation of hyper-personalized communication begins. Choosing the right channel and the right time is the key to success. The more targeted and relevant the communication/messaging is the higher rate of prospect conversion sales and post-campaign measurement and evaluation.

Traditional software does exactly what it is programmed to do. AI-powered advertising systems can improve their performance over time in response to the data analyzed. In addition to “learning” on its own, many AI systems require human experts to manually train AI systems on more and increasingly diversified data, so the system has better information from which to make predictions and improve the ranking of predictor variables. For instance, an AI-powered system could include scoring rules created by the user, then analyze how well it performs over time, comparing each meta score to data results on prospect conversions of new customers.

AI tools may not always automatically know the actions to achieve overall marketing goals. AI tools require time to learn specific organizational goals, customer preferences, and historical trends. In addition to time, this also requires data quality assurance. If the artificial intelligence tools have not trained with accurate, timely, and representative data, these tools will make less than optimal decisions, reducing the value of the tool and subsequent effectiveness of the advertising or marketing campaign. In one embodiment, this invention can integrate and use human training of AI tools to improve their effectiveness and align them with organizational goals.

Many advertising platforms provide increasing volumes of data every day, including measurable impressions, click-through rates, bid levels, demographics, psychographic, engagement predictors, conversions triggers, and much more. While companies can produce good advertising, a measure that advertising, and improve ads based on what they learn, AI digital advertising across search engines, content, and social media channels, generates a virtually unlimited ability to create data insights to identify the best performing messaging and media content. What is virtually impossible for human advertising professionals is what makes AI an ideal fit for the advertising and marketing industry.

With the right data, AI-powered micro-targeted customer identification tools can detect patterns at scale then predict what changes to campaigns will improve performance against a specific key performance indicator (KPI). This happens in seconds. Rather than the hours, days, or weeks it might take a human to analyze, test, and iterate new initiatives across multiple campaigns. For each micro-audience, AI tools can choose the right creative message/imagery, right channels, right time, right pricing/promos, right budget mix, and right execution format. All designed to increase the return on ad spend, reduce staffing resources, identify ineffective budget items and improve ROI. In one embodiment, this invention can test and analyze iterations of advertising campaigns to optimize return on advertising spend ROAS. KPIs can include return on ad spend, cost to acquire, cost to retain, increase in traffic/visitors, increase in conversions, cost per click, cost per lead, click volume, lead volume, the total cost of engagement (COE), COE to sales ratio, or COE to profit ratio.

Although undetectable to the regular consumer, AI is critical to the infrastructure that underlies advertising products on practically all advertising platforms. Programmatic platforms typically use AI to manage real-time ad buying, selling, placement, and reporting, including programmatic exchanges, third-party networks, and advertising on platforms like Facebook, Instagram, Snapchat, etc.

Performance optimization is one of the key use cases for AI in advertising. Machine learning algorithms analyze ad performance across specific platforms then provide recommendations on performance improvement. Platforms may use AI to intelligently automate actions that should be taken based on best practices, saving significant time and money. In other cases, AI predictive engines highlight performance issues that go undetected by human review and analysis. In most cases, AI can automatically manage ad performance and spend optimization, making decisions entirely on its own about how best to achieve advertising KPIs and recommending a fully optimized budget. Omnichannel engagement mix analysis will utilize a search engine, social media, display, mobile, CTV/OTT broadcast, digital out-of-home, email, web landing sites, native and in-app ads to refine and improve advertising results. AI systems can analyze past audiences and ad performance, weighing variables against specific KPIs, add real-time performance data, then identify new audiences likely to buy. In one embodiment, this invention can integrate AI into their KPI evaluations.

AI-powered systems now have the capability to partially or fully create advertising messaging and creative executions from an inventory of images and video clips. This creative is based on what would work best to meet certain marketing goals and objectives, matched with pre-identified enhanced personas and audience segmentation criteria. Third-party tools can utilize smart algorithms to write ad copy and choose the ideal creative messaging and images. These systems leverage natural language processing (NLP) and natural language generation (NLG) to generate ad copy that performs as well or better than human-written copy—in a fraction of the time and at scale. In one embodiment, this invention can integrate and use NLG systems to generate ad copy based on predicted responses from different personas.

Natural Language Processing (NLP) tools allow humans to query large sets and receive answers in clear, human language. This technological advance greatly increases data access and improves overall data capabilities, particularly extracting useful information from diverse and unstructured data sets. In one embodiment, this invention can integrate and use NLP systems to standardize the format of data from a variety of different sources.

Identifying potentially valuable insight hidden in vast data repositories becomes increasingly important as more people within an organization can take data-driven insights.

Extended reality (XR) is an emerging technology that provides an enhanced visual overview and understanding of large data sets. XR facilitates new visualizations that allow users to draw a deeper meaning from data and how these results impact consumers and larger behavior modeling. In one embodiment, this invention can integrate XR into its user dashboards to allow marketers to better understand the effectiveness of their campaigns.

AI has inspired Creative Predictive Design (CPD), which utilizes statistical and analytical techniques that can be used to predict future consumer behavior. Given that each consumer is unique in their media consumption and buying behavior, advertising content should also be unique (i.e., ads for each consumer would be tailored to meet their individual needs). With the latest AI capabilities, it is possible to create consumer-driven content, making ads more productive and increasing ROI. With the ever-increasing wealth of available consumer data, AI is ideally suited to predict the ads that will perform best within very specific consumer segments.

Through AI, Real-Time Bidding (RTB) is a technique based on the streaming of real-time consumer data. AI offers the capability to place the lowest bid that enables the media buyer to acquire ad space on a specific media platform. Much like automated financial trading, RTB can effectively place messaging within specified media at the lowest possible cost with the best possible results. In one embodiment, this invention may leverage RTB to increase the ROAS by optimizing the advertising spend.

Machine Learning algorithms have simplified the process of ad positioning that historically took human time and resources to decide on the right position for their ad(s). This process now takes several seconds with the help of AI technology. In addition, the iterative process continues to improve the algorithms moving forward, so performance continues to maximize impressions and results for current and future campaigns. In one embodiment, this invention can integrate and use AI to optimize ad positioning.

The latest adaptation of AI in advertising is “Sentiment Analysis.” By using natural language processing (NLP), computational linguistics, and various other techniques, AI can assess consumers' emotional states. Understanding consumer sentiment allows AI to better understand, process, and report consumer opinions, one of the most valuable consumer data sources. As AI continues to build a complete profile of a consumer, ad creative, placement and content will positively impact marketing and advertising results over the short and long term. In one embodiment, this invention can integrate and use sentiment analysis to further optimize creative assets for a specific customer persona.

Brands are now actively reinventing the creative process. Combining AI technology accuracy with human intuition exponentially improves the creative process and results.

New AI technology can tailor a brand's marketing language and tone, which sounds exactly like what human copywriters produce. AI will create an infinite number of ad copy variations at scale as the iterative process continues, based on AI algorithms designed to increase clicks and customer engagements. An AI algorithm is a set of rules, inferences, deductive and inductive reasoning and other logic and probabilistic means by which a computer is able to learn to operate on its own. The computer continues to gain information, insights and knowledge to improve processes and run tasks more efficiently and effectively. Personal AI rules are included, so a copy is tagged with unique engagement predictors, motivators, behaviors to further refine advertising messaging and placement. In one embodiment, this invention can customize AI rules for a specific client to optimize the customization of their creative assets.

This process can re-direct copywriters to work on longer-form and higher-value projects, improving performance and driving financial efficiency.

AI users must ensure consumer data is used and sourced ethically and in compliance with standards (like GDPR). Companies risk severe penalties and reputation damage should there be any divergence from established legal rules and guidelines. KPIs like ROI and efficiency can be quantifiable, but any AI deployment must also demonstrate how the customer experience is improved at all levels of the customer journey.

AI technology also directly affects reducing and eliminating poor customer support experiences. Reports show that many customers stop buying products and services due to poor customer service. These include long wait times, repeating information for each new question, and getting shuffled to multiple sources trying to resolve a problem. The customer expectation of resolving questions quickly is the standard. Leveraging AI technologies allows organizations to make omnichannel customer engagement the standard—since customers use multiple devices (mobile devices, smartphones, laptops, social media, chat, email, self-service, websites, etc.) to interact with companies during the customer journey. Customers expect their interactions to flow seamlessly from one channel to the next, even when transitioning from self-service to live support. In one embodiment, this invention can integrate and use AI to optimize the delivery of ad creative across multiple platforms and devices.

As marketers implement omnichannel customer engagement solutions to provide a complete communication strategy and solution to satisfy customers, AI communications platforms and enhanced technologies are beginning to be deployed to (1) provide consistent customer information between all marketing channels (2) personalizing the customer experience at all touchpoints along the customer journey, (3) eliminating customer frustration with erroneous or incorrect information, (4) diversifying the customer base and (5) increasing brand loyalty and closed sales.

Omni-channel engagement techniques provide adequate control of all information, create a cohesive and consistent brand image over time, and allow for an integrated approach to all external marketing and communication efforts. As the era of digital communication continues to evolve, it becomes vital for businesses to leverage a connected approach to communication, using a customer-first mindset, enhanced and improved with AI technology. In one embodiment, this invention can integrate omnichannel engagement strategies to target customers at different points in the customer journey.

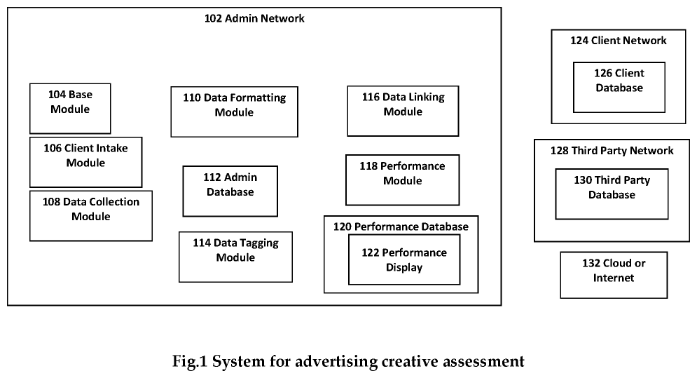

FIG. 1 is a system for advertising creative assessment. This system comprises an admin network 102, which may be a computer or network of computers that receives data through the cloud or internet 132. This data may then be stored, sent, altered, or used in programs or modules. A base module 104, which may initiate other modules within the admin network 102 based on a predefined order or based on criteria that would call for a module to be initiated. A client intake module 106, which may prompt a client for campaign information and which metrics are most relevant to the client's goals. For example, a client may be more interested in ad revenue, CTR, and lead generation than in brand awareness, repeat customers, and ad cost optimization. A data collection module 108 may collect data from various sources, including the client network 124, one or more third-party networks 128, or even from databases within the admin network 102 such as the performance database 120. The data is then sent to the data formatting module 110. A data formatting module 110, which may format data from multiple sources into a single or a set of formats so that all of the data can be stored in a single database or set of databases and so that the data is useable by other modules on the admin network 102. An admin database 112, which may be a collection of data on various advertising campaigns, clients, customers, creatives, etc. which may be used as the input to various modules or AI that are part of the admin network 102. A data tagging module 114 may tag data as personal data, behavioral data, customer journey data, marketing data, medium data, creative data, or another type of data. Data may receive more than one tag if applicable. Data tagging may use natural language processing, known data structures, AI algorithms, etc., to identify data. For example, a phone number data may be identified as personal data because of the format of the number: (xxx) xxx-xxx. A data linking module 116 may identify related pieces of data that are not linked and establish a link. For example, an entry in the admin database contains the name Bob Adams and an address, while another contains the name Bob Adams and an email. These two pieces of data may be linked to create a more complete dataset on Bob Adams.

In some cases, the data linking module 116 may not be sure of a relationship may require a threshold of certainty before data is linked. A performance module 118, which may use all of the linked data from the data linking module 116 as well as any unlinked but relevant data from the admin database 112 in order to assess several metrics relevant to advertising campaign performance such as ad revenue, ad spend/earning ratio, CPM, CTR, etc. This data is then stored in the performance database 120. A performance database 120 may store the results of the performance module so that the data can be displayed to the client. The data may also be collected by the data collection module to iteratively update the data on the campaign, to provide information that other campaigns could use, or to train an AI. A performance display 122 may display performance metrics to the client regarding the client's ad campaign or campaigns.

A client network 124, which may be a computer or network of computers that send data through the cloud or internet 132 to the admin network 102. The client network 124 may also be able to receive data from the admin network 102, such as the evaluation results of a piece of creative or creatives, real-time analytics, promotional offers, etc. A client database 126 may contain advertising creatives, analytics, demographic information, or any other data that may be useful in optimizing an advertising campaign. A third-party network 128, which may be a computer or network of computers that send data through the cloud or internet 132 to the admin network 102. The third-party network 128 may be comprised of assets from multiple third parties, and multiple third-party networks 128 may send data to the admin network 102. Examples of third parties may include ad exchanges, search engines, advertisers, ad optimization agencies, other clients, former clients, or any other party which may have access to relevant advertising data. A third-party database 130 may contain advertising creatives, analytics, demographic information, or any other data that may be useful in optimizing an advertising campaign. A cloud or internet 132 may be a wired and/or a wireless network. The network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort and relies on sharing of resources to achieve coherence and economies of scale, like a public utility. At the same time, third-party clouds enable organizations to focus on their core businesses instead of expending resources on computer infrastructure and maintenance.

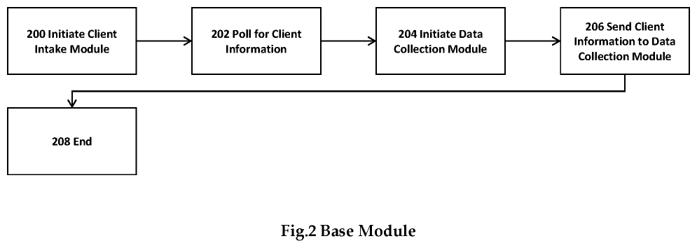

FIG. 2 displays the functioning of the “Base Module.” The process may begin with The base module 104 initiating the client intake module 106. The client intake module 106 will collect data from the client. In some cases, the client may have already given intake information, in which case this step may be skipped or replaced with the initiation of another module, such as a login module, at step 200. The base module 104 may poll for client information from the client intake module 106 at step 202. The base module 104 may initiate the data collection module 108, which will collect data from various sources, including the client's own data, at step 204. The base module 104 may send the client information from the client intake module 106 to the data collection module 108. This data may affect which sources data is collected from or provide credentials to sources, at step 206. The base module 104 may end at step 208.

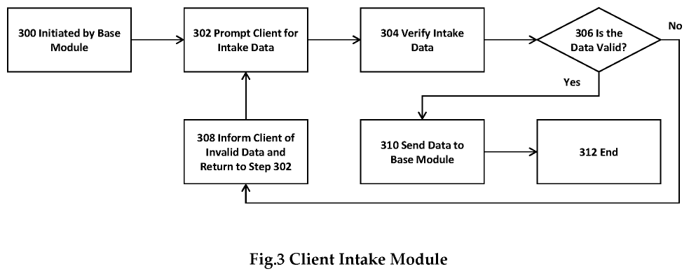

FIG. 3 displays the functioning of the “Client Intake Module.” The process may begin with the client intake module 106 being initiated by the base module 104 at step 300. The client intake module 106 may prompt the client to enter or upload intake data. Intake data may include ad campaign data, database access credentials, account registration information, personal identifying information, company information, billing information, or any other information that the client has access to that may be useful to the system. Some intake data may be required, while other intake data may be optional, at step 302. The client intake module 106 may verify the intake data. Verification of data may differ based on the type of data. For example, if some of the intake data is a set of credentials to access the client database 126, verification may involve testing that the credentials provide access. For another example, verification of personal information or company information may involve follow-up questions such as “have you ever lived at one of the following addresses?” at step 304. The client intake module 106 may determine if some or all of the intake data is valid. Invalid data may include both data that failed verification and data that is otherwise in error. For example, letter characters such as ‘a’ or ‘b’ in the field for a phone number may be invalid at step 306. If some or all of the intake data is invalid, the client intake module 106 may inform the client of which data is invalid and return to step 302. The client intake module 106 may further inform the client why the data is invalid and how it could be corrected. The client intake module 106 may save valid data so that the client does not need to renter valid data at step 308. If all of the intake data is valid, the client intake module 106 may send the data to the base module 106 at step 310. The client intake module 106 may end at step 312.

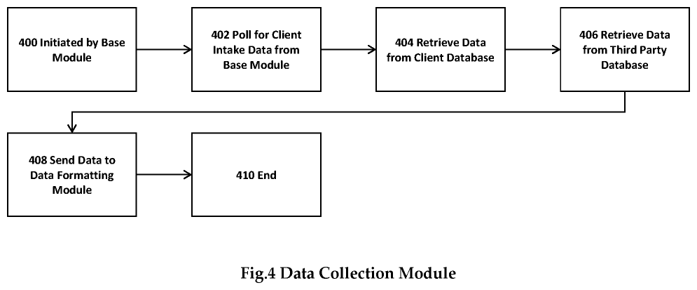

FIG. 4 displays the functioning of the “Data Collection Module.” The process may begin with the data collection module 108 being initiated by the base module 104 at step 400. The data collection module 108 may poll for client intake data from the base module 104. Client intake data may be important in gaining access to client data. Client intake data may also include client goals and relevant metrics, which may inform which third-party sources to request data from at step 402. The data collection module 108 may retrieve data from the client database 126. The data collection module 108 may collect all data from the client database 126 or may only request a subset of data. Credentials may be required to connect to the client network 124 in order to access the client database 126, at step 404. The data collection module 108 may retrieve data from one or more third-party databases 130. Which third-party networks 128 the data collection module 108 connects to may be based on the intake information provided by the client. For example, if the client provided information that was associated with a third party ad exchange, then the data collection module 108 may collect data from that third party ad exchange that the client may not have in the client database 126. There may be default third-party networks 128 that are always accessed by the data collection module 108 for any client at step 406. The data collection module 108 may send the data retrieved from both the client and the third parties to the data formatting module 110, at step 408. The data collection module 108 may end at step 410.

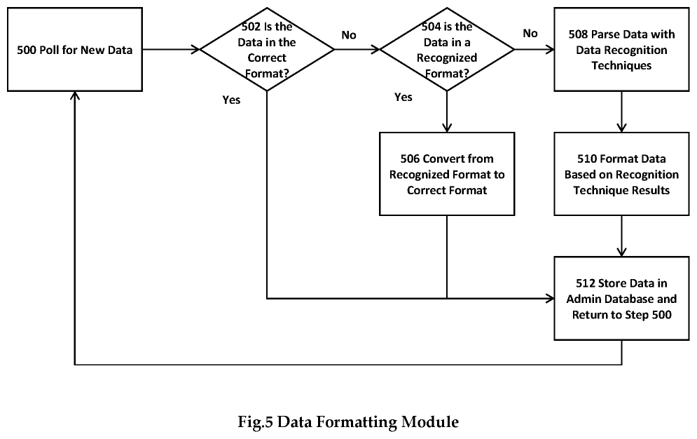

FIG. 5 displays the functioning of the “Data Formatting Module.” The process may begin with the data formatting module 110 polling for new data. New data may come from the data collection module 108. New data may come from other sources, such as the performance database 120, at step 500. The data formatting module 110 may determine if the data is already in the correct format to be stored in the admin database 112. If the data is already in the correct format, the data formatting module 110 may skip to step 512 at step 502. If the data is not in the correct format, the data formatting module 110 may determine if the data is in a recognized format but not the correct format for storage in the admin database 112, at step 504. If the data is in a recognized format, the data formatting module 110 may convert the data to the correct format using a conversion algorithm. For example, data for a creative image may be stored as a .png, which could be converted into a .jpeg using existing .png to .jpeg conversion software. The data formatting module 110 may skip to step 512 at step 506. If the data is not in a recognized format, the data formatting module 110 may be parsed using one or more data recognition techniques. Data recognition techniques are algorithms, software, AI engines, or other methods of identifying unstructured or partially structured data. For example, pattern recognition, natural language processing, fuzzy logic AI, data reconstruction software, etc. More than one technique may be applied to the data, and the results of the technique may be combined with other techniques on the same set of data at step 508. The data formatting module 110 may format the data based on the results of the data recognition technique or techniques. Unrecognized data may be discarded or stored for future analysis when techniques improve or when supplementary data is available at step 510. The data formatting module 110 may store the formatted data in the admin database 112 and return to step 500 at step 512.

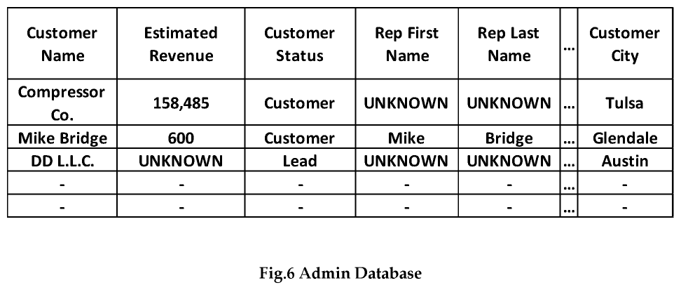

FIG. 6 displays the “Admin Database.” The admin database 112 may be a collection of formatted data from the client and various third parties. This data may include any data related to the client's advertising campaign or creative. The admin database 112 may contain this information for all clients, or each client may have an admin database 112 assigned to them. Because some of the data may have been unstructured or semi-structured before being formatted by the data formatting module 110, some data entries in the admin database 112 may be incomplete. The figure displays an example of a possible configuration of contact data in a table, but note that in practice, the disparate data sources and multiple types of data may not be easily expressible as a table. For example, a data entry for an advertising creative may not be associated with a phone number, customer status, or representative but would likely be associated with meta tags, color schemes, image size, and webpages. 600.

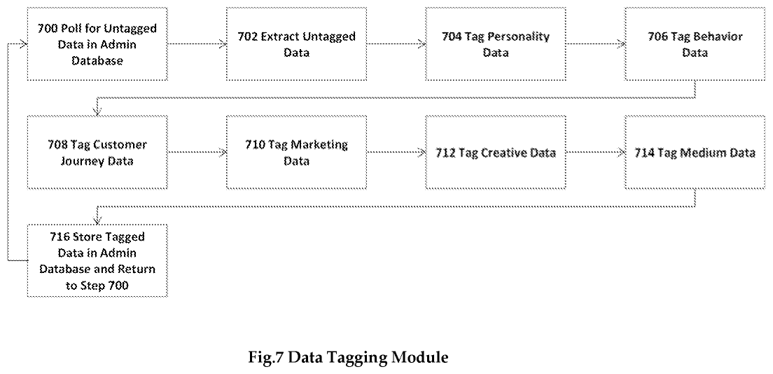

FIG. 7 displays the functioning of the “Data Tagging Module.” The process may begin with the data tagging module 114 polling for data in the admin database 112 that is not tagged. The data polled for may be data that is new to the admin database 112 or data that has been untagged. Data may be untagged, for example, if the data has changed and requires re-assessment at step 700. The data tagging module 114 may extract the untagged data from the admin database 112 at step 702. The data tagging module 114 may tag data related to customer personality as personality data. Customer personality data may be any data that allows the creation of generalized persona abstractions fine-tuned over many iterations down to a limited set of synthesized or ‘primary’ personas representing the underlying personalities of customers as people. Example data may include demographic data such as age, sex, gender, political affiliation, marital status, etc., at step 704. The data tagging module 114 may tag data related to customer behavior as behavior data. Customer behavior data may be any data that further delineates personality data, such as interests, motivations, emotions, influences, etc. This data may be used to better understand each customer's engagement drivers, actionable behaviors, and intent. Example data may include influences (adoption curve, celebrities, Influencers, friends, family, online recommendations), past purchases, interests, hobbies, emotional maturity based on life stage (e.g., Plotkin's wheel); and events which may materially affect behavior—e.g., family dynamics, holidays, job, celebrations, life events, seasons, months/days/hours of the year or other external events, at step 706. The data tagging module 114 may tag data related to the customer journey as customer journey data. Customer journey data may be data that indicates customer engagement workflow from initial engagement through to conversion or other defined performance metrics. The customer journey may include the steps of awareness, consideration (action engagement), trying (take next step towards action including disclosure of self), buying (actual purchase and degree of repeat purchases after that), and loyalty (sharing the experience with others, transition to advocacy). Example data may include product purchases, click-throughs, browser cookie data, and product mentions/reviews at step 708. The data tagging module 114 may tag data related to client marketing as marketing data. Marketing data may be any data that relates to traditional client-defined information about its product (or service). Marketing data may include data related to the client's brand (value, purpose, principles, guidelines, messaging, scaling), product (solution, service, features, advantages, benefits, uniqueness), calendar (marketing, PR, social, communications, editorial, holidays, seasons, etc.), price, and promotion (audience, segment, location, timing). Critical to any advertiser is the scheduling and activation of ad campaigns. An internal content calendar is useful in this regard in terms of scheduling and providing contextual data. Viewing creatives in the context of the Christmas holidays may be different than the rest of the year, or winter clothes in an ad campaign set in summer, are examples of how the content calendar can provide context at step 710. The data tagging module 114 may tag data related to advertising creatives as creative data. Creative data may be any data related to advertising creatives such as banner ads, video ads, print ads, etc. In most situations, the client will have already worked with an ad agency to provide the first iteration of a creative, and a full understanding of the underlying assumptions and intended messaging behind the design and format of the creative is essential. This data includes such factors as the choice of words/messaging and fonts, colors and hue, visuals (pictures, videos, graphics), actors and participants (peoples, products, animals, abstracts/drawings), emphasis (tone, size, emojis, highlights), at step 712. The data tagging module 114 may tag data related to the client's chosen advertising medium or mediums as medium data. Medium data may be any data that relates to the choice and mix of which medium or channels the creative will be placed and the allocation of the marketing budget for each channel. The most common activation channels for Gen Zs/Millennials, for example, may be search, social media, OTT video, and mobile, whereas Baby Boomers may be more receptive to broadcast TV, Email, Print, Events, etc., at step 714. The data tagging module 114 may store the tagged data in the admin database 112 and return to step 700. If any data was extracted but is not tagged, it may be tagged as “other” or “untagged” and may be stored in another database or discarded. Note that data may have more than one tag at step 716.

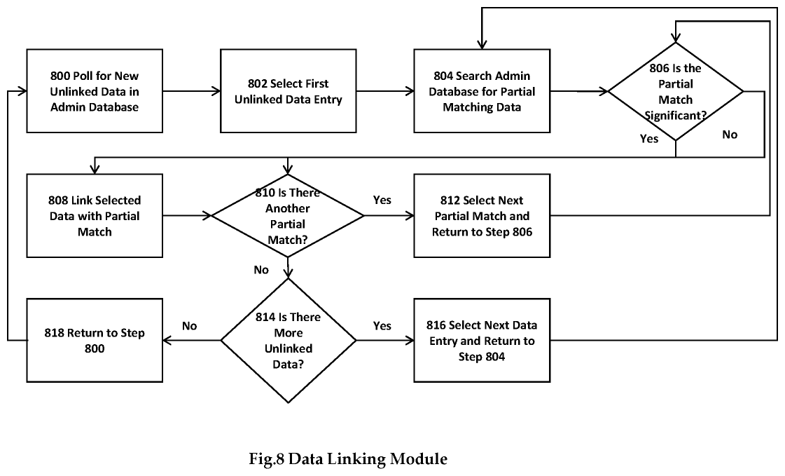

FIG. 8 displays the functioning of the “Data Linking Module.” The process may begin with the data linking module 116 polling for new unlinked data in the admin database 112. The data linking module 116 may also periodically check for any unlinked data in the admin database 112 to capture unlinked data that was unable to be linked before but may be linked to new data at step 800. The data linking module 116 may select the first piece of unlinked data from the new unlinked data in the admin database 112. A piece or entry of unlinked data may be a set of data which is related to the same subject. For example, a set of data that contains a customer name, phone, and address may be one piece of data or one data entry, as opposed to a set of data that contains ten phone numbers for ten different clients, which may be 10 entries or pieces of data, at step 802. The data linking module 116 may search the admin database for a data entry that partially matches the selected unlinked data entry. A partial match may be one where some of the data in the entry is identical or similar. For example, one data entry contains a customer's name, phone, and email, while another entry contains a matching name and email but has an IP address and no phone number. These two entries may be a partial match for each other. Identical matches may be considered as well but may also be treated as repeated data, and one of the identical data entries may be deleted at step 804. The data linking module 116 may determine if the partial match is significant. Several factors may determine significance, including which parts of the data are matching, how many parts are matching, and how close those matches are. For example, the selected data entry contains the name “Sarah Smith,” the phone number (111) 222-3333, and the unidentified string “sarahsmith2,” and two partial matches are found. The first partial match contains the name “Sarah Smith,” the phone number 222-3333, and the email “sarahs@web.com.” This may be a significant match because there are two matches: name and phone number, which have a high degree of uniqueness. Even though the phone number was not an exact match, the only difference is the lack of an area code in the partial match, which is a common omission. The second partial match contains the name “Sara Smith,” the username for a specific site, “sarahsmith2”, and an encrypted password. This may not be a significant match because while there are still two matches, a similar name is not a strong indicator that the data relates to the same person on its own because misspelling one's own name is an uncommon error. The other match between the unidentified string and the username is also suspect since it isn't clear that the matching strings are both usernames or are even usernames for the same website. Significance may be determined by assigning each matching piece of the partial matching data entries a score based on how close the match is and what parameter of data is being matched. This score may need to pass a threshold value, i.e., 100, in order for a partial match to be considered significant at step 806. If the partial match is significant, the data linking module 116 may link the selected data with the partial match. This linking may indicate to other modules that use this data to be treated as related data at step 808. The data linking module 116 may determine if there is another partial match for the selected data at step 810. If there is another partial match, The data linking module 116 may select the next partial match and return to step 806 at step 812. If there are no more partial matches, the data linking module 116 may determine if there is any more unlinked data at step 814. If there is more unlinked data, the data linking module 116 may select the next unlinked data entry and return to step 804. Because some data in the admin database 112 may be unique enough to never be linked, this step may cause the data linking module 116 to run continuously even when no new data is present. In this case, the data linking module 116 may be manually or automatically terminated at step 816. If there is no more unlinked data in the admin database, the data linking module 116 may return to step 800 at step 818.

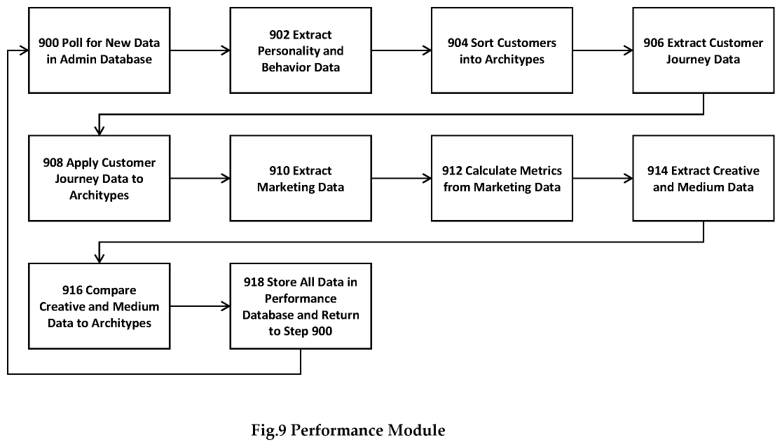

FIG. 9 displays the functioning of the “Performance Module.” The process may begin with the performance module 118 polling for new data in the admin database 112. New data may have recently been added, linked, tagged, or otherwise changed in the admin database 112, at step 900. The performance module 118 may extract data tagged as personality or behavior data from the admin database 112, at step 902. The performance module 118 may sort customers into archetypes based on their personality and behavior data. New customers may be sorted into existing archetypes, or archetypes may be generated from local clusters of similar personality and behavioral data. Each archetype is tagged with unique engagement predictors: motivations, behaviors, and interests to make data actionable for further downstream predictive creative tagging and find new ‘look alike’ audiences. Secondary and tertiary archetypes may also be linked to the primary archetype based on specific segmentations—e.g., demographics, location, socio-economic status, etc., at step 904. Meta rules may also be applied at this level, e.g., when certain personas should not be used in given situations. For example, the archetype “Motivated Michelle” comprises professionals in their late 20s.

The performance module 118 may extract customer journey data from the admin database 112. The performance module 118 may only extract customer journey data relevant to customers of the client if other customer data is also available at step 906. The performance module 118 may apply the customer journey data to the archetypes so that each archetype is associated with a breakdown of what portion of that archetype is at what step of the customer journey. For example, for customers who fall under the archetype “Motivated Michelle,” 50% may be unaware of the product or brand, 20% may be aware, 15% may be willing to try, 10% may have purchased the product, and 5% may be loyal to the product or brand and advocate to others, at step 908. The performance module 118 may extract marketing data from the admin database 112 at step 910. The performance module 118 may calculate metrics from marketing data. These metrics may include key performance indicators as selected by the client provided intake information such as return on ad spend, cost to acquire, cost to retain, increase in traffic/visitors, increase in conversions, cost per click, cost per lead, click volume, lead volume, the total cost of engagement (COE), COE to sales ratio, or COE to profit ratio, at step 912. The performance module 118 may extract data tagged as creative or medium data from the admin database 112, at step 914. The performance module 118 may compare creative and medium data to archetypes to estimate each archetype's engagement level based on the type of creative, the content of the creative, and the mediums through which the creative is being delivered. The performance module 118 can then use this information to identify “look-alike” archetypes which are archetypes that are similar to archetypes that the creative engages or the products sells well with. These “look-alike” archetypes may contain customers that could be engaged with changes to the creative or medium at step 916. The performance module 118 may store all of the extracted and calculated data in the performance database 120 and return to step 900 at step 918.

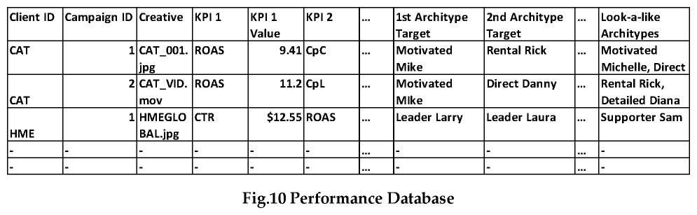

FIG. 10 displays the “Performance Database.” The performance database 120 contains the results of analysis by the performance module 118 stored so that it can be easily accessed and displayed by the performance display 122. Example data in the performance database includes campaign, client, and creative identifiers, key performance indicators (KPI) values and the order in which the client prioritizes the KPI, target archetypes which may be intended targets or indicate which archetypes are most responsive to the creative, and look-a-like archetypes which may be archetypes that are similar to the targeted archetypes but are not being targeted or enticed by the creative.

AIA market and advertising domain experts may review the preliminary creative and, based on the persona classifications plus the key data gathered from the content cube framework (namely product, brand, promotion, creative mix, platform medium, calendar, and all the other attributes defined for each discrete campaign) make a holistic determination of which 4-5 top ‘preliminary creative’ are best suited for each persona and adding additional tags manually and automatically to these selections. These are then tested through simulation to verify the right alignment of personas and creative has been made for each primary persona and any micro-target audience derivatives from this. In this way, new creative variations can be generated with more much precise and relevant targeting than the simplistic prevailing means of targeting used by the original creative or creatives' campaign manager.

In the first example, the client is a cookie company. Creatives received from the client display a box overflowing with assorted cookies. Data from the client, as well as data from a diverse array of third parties sources which provide additional signals and insights, is ingested by the system. After the data has been integrated and analyzed using AI techniques, the performance of the creative with specific personas is available for assessment. Based on this assessment, marketing experts determine that while the creative is doing well with a large portion of the target demographic, there is low engagement with the persona “Emily Innovation.” Further, the largest persona, “Megan Majority,” could be better targeted, which would yield very high ROAS, which is the highest KPI for the client. The marketing experts create multiple new creatives. The first group of creatives targets customers with the “Emily Innovation” persona. These creative contain a wider color palette, keywords/phrases like “customize” or “build your own,” and a more organized display of cookies. The other group of creatives target the “Megan Majority” customers and may be a small change from the original creative. They may include the same box of cookies but be shifted to the side so that text can be added. They may include the price of the cookies if “Megan Majority” customers do not respond well to price ambiguity or tend to overestimate the price if none is listed. Each group of creatives has its predicted performance measured by simulating the customer's interests, motivations and engagement triggers response using the same method of analyzing the original creative. Then the creative with the highest predicted performance based on the client selected KPI is suggested for that persona. The client can directly target “Megan Majority” and “Emily Innovation” customers with separate creatives. This process is dynamic so new data, signals and insights are received from client and third party sources during the activation of a campaign, or if the kPIs are modified, the formulation and ranking of the personas and creative may be recalibrated accordingly.

In a second example, the client is a construction equipment company. A creative received from the client displays a video of one of the company's excavators digging up dirt. Data from the client, as well as data from third party sources, typically many billions of data points, which provide signals, insights and sentiment that may be relevant to the creative mandate and is ingested by the system. After the data has been integrated and analyzed using AI techniques, the performance of the creative with specific personas is available for assessment. Based on this assessment, marketing experts determine that because the company makes most of its revenue selling equipment to other businesses, not individual sales, the creative is designed to target customers who have decision-making power in those businesses. The creative does well with the persona “Adaptable Adam,” but not with a look-alike persona “Social Sam.” Market analysis shows that while “Social Sam” is less likely to be in a business position than “Adaptable Adam,” it is still common. The market experts create a group of creatives which would better target the “Social Sam” persona. These creatives may be a re-edit of the original video creative or contain new footage, images, or text or other digital media elements which will improve engagement and conversion relative to the defined KPIs. The creatives that better target “Social Sam” may simply be videos that involve more screen time for human operators of the equipment and their level of satisfaction or pleasant background music instead of the sounds of construction. The new group of creatives has its predicted performance measured by simulating the customer response using the same method of analyzing the original creative. Then the creative with the highest predicted performance based on the client selected KPI is suggested for that persona. This way, the client can now better target customers with “Social Sam” personas.

What is claimed is:

1. A method for advertising optimization comprising:
collecting a first set of data from the client;
collecting a second set of data not from the client;
formatting the first and second set of data into a data lake;
tagging a subset of the data with a category tag;
linking related data within the data lake; and
predicting values for a set of performance metrics based on AI processing of client and non-client data, wherein the predicted values of the set of performance metrics are based on AI analysis of data within the data lake.
